(19) United States
(12) Patent Application Publication
(10) Pub. No.: US 2017/0362764 A1
(43) Pub. Date: Dec. 21, 2017

(54) WALL-MOUNTED WASHING MACHINE AND INSTALLATION METHOD THEREOF

(71) Applicant: Dongbu Daewoo Electronics Corporation, Seoul (KR)

(72) Inventor: Sang Ki HAN, Seoul (KR)

(21) Appl. No.: 15/287,566

(22) Filed: Oct. 6, 2016

(30) Foreign Application Priority Data
Jun. 20, 2016 (KR) 10-2016-0076784

(51) Int. Cl. D06F 39/12; F16B 39/22; F16B 43/00; F16M 13/02

(52) U.S. Cl. CPC D06F 39/125; F16M 13/02; F16B 39/225; F16B 43/001

(57) ABSTRACT

A fastener kit can securely affix a washing machine on a lightweight wall. The washing machine includes a rear panel for coupling to the wall through the fastener kit. A tub configured to contain washing water may be integrally formed with the rear panel. The fastener kit has an anchor rod with one end section forming tight contact with the inner surface of a fastening hole on the lightweight wall by using a chemical anchor. The other end section of the fastener kit is coupled to the rear panel.

### CROSS-REFERENCE TO RELATED APPLICATION

This application is based on and claims priority from Korean Patent Application No. 10-2016-0076784, filed on Jun. 20, 2016, the disclosure of which is incorporated herein in its entirety by reference for all purposes.

### TECHNICAL FIELD

Embodiments of the present disclosure relates to a wall-mounted washing machines and an installation method thereof.

### BACKGROUND OF THE INVENTION

A wall-mounted washing machine can be installed on a wall, which is particularly useful for rooms with relatively small spaces.

Generally, a wall-mounted washing machine includes a cabinet, a tub disposed within the cabinet and configured to store washing water, a drum rotatably installed in the tub and configured to accommodate laundry or other washing objects, a drive device configured to supply power to and drive rotation of the drum, a water supply device configured to supply washing water into the tub, and a drain device configured to drain washing water from the tub to the outside of the cabinet.

Once washing operation is started, washing water is supplied into the tub and the drum by the operation of the water supply device. The drum is rotated by the drive device. At the end of washing, washing water in the tub and the drum is drained to the outside of the cabinet by the operation of the drain device.

A wall-mounted washing machine usually is designed with a compact size. For example, it can be installed on a wall of a bathroom that typically has a small area.

However, a wall made of a structurally-weak lightweight material usually lacks the mechanical strength and stability needed to support the weight of a washing machine attached thereto, especially if ordinary bolts are used for affixation.

In particular, due to vibration caused by the washing machine operation, especially in the dewatering and rinsing cycles, the affixture between the washing machine and the wall may become loose. In a worse scenario, the washing machine may even fall from the wall, causing damage to the washing machine as well as the wall, and even beyond.

### PRIOR ART DOCUMENTS

Patent Document 1: Korean Patent Application Publication No. 10-2013-0064624 (published on Jun. 18, 2013)

### SUMMARY OF THE INVENTION

In view of the above, embodiments of the present disclosure provide a wall-mounted washing machine capable of being secured and/or affixed to a structurally-weak lightweight wall having regular or irregular cavities and an installation method thereof.

In accordance with an aspect of the present invention, there is provided a wall-mounted drum type washing machine, comprising: a rear panel mounted on a wall; a tub integrally formed with the rear panel and configured to store washing water; a drum rotatably installed in the tub; a chemical anchor put into a fastening hole formed in the wall; and a fastener kit having one end portion inserted into and fixed to the fastening hole, and the other end portion fixed to the rear panel.

As described above, according to embodiments of the present disclosure, a washing machine can be mounted on a structurally-weak lightweight wall. Furthermore, vibration caused by washing machine operation, especially in dewatering and rinsing cycles, can be attenuated and restrained from being transmitted to the porous wall. Thus, noise generated by vibration can be reduced and/or prevented. This can also significantly reduces the risk of the washing machine falling from the wall due failure of the fastening mechanism.

### BRIEF DESCRIPTION OF THE DRAWINGS

FIG. 1 is a perspective view illustrating an exemplary wall-mounted washing machine according to one embodiment of the present disclosure.

FIG. 2 is a partial sectional view illustrating an exemplary wall-mounted washing machine according to one embodiment of the present disclosure.

FIG. 3 is an enlarged sectional view illustrating an exemplary fastening mechanism between the wall-mounted drum type washing machine according to one embodiment of the present disclosure and the lightweight wall.

FIG. 4 is a cross-sectional view illustrating a process in which a fastening hole is formed in the lightweight wall in order to install the wall-mounted drum type washing machine according to one embodiment of the present disclosure.

FIG. 5 is a cross-sectional view illustrating an exemplary process in which debris-like extraneous material existing within the fastening hole are removed by a cleaning brush in order to install the wall-mounted drum type washing machine according to one embodiment of the present disclosure on the lightweight wall.

FIG. 6 is a cross-sectional view illustrating an exemplary process in which particle-like extraneous material existing within the fastening hole are removed by an air flow in order to install the wall-mounted drum type washing machine according to one embodiment of the present disclosure on the lightweight wall.

FIG. 7 is a cross-sectional view illustrating an exemplary process in which a chemical anchor is put into the fastening hole in order to install the wall-mounted drum type washing machine according to one embodiment of the present disclosure on the lightweight wall.

FIG. 8 is a cross-sectional view illustrating an exemplary process in which an anchor rod is inserted into and fixed to the fastening hole in order to install the wall-mounted drum type washing machine according to one embodiment of the present disclosure on the lightweight wall.

FIG. 9 is a flowchart illustrating an exemplary method of installing the wall-mounted drum type washing machine according to one embodiment of the present disclosure.

### DETAILED DESCRIPTION

Hereinafter, configurations and operations of embodiments will be described in detail with reference to the accompanying drawings. The following description is one of various patentable aspects of the disclosure and may form a part of the detailed description of the disclosure.

However, in describing the disclosure, detailed descriptions of known configurations or functions that make the disclosure obscure may be omitted.

The disclosure may be variously modified and may include various embodiments. Specific embodiments will be exemplarily illustrated in the drawings and described in the detailed description of the embodiments. However, it should be understood that they are not intended to limit the disclosure to specific embodiments but rather to cover all modifications, similarities, and alternatives which are included in the spirit and scope of the disclosure.

The terms used herein, including ordinal numbers such as “first” and “second” may be used to describe, and not to limit, various components. The terms simply distinguish the components from one another. When it is said that a component is “connected” or “linked” to another component, it should be understood that the former component may be directly connected or linked to the latter component or a third component may be interposed between the two components. Specific terms used in the present application are used simply to describe specific embodiments without limiting the disclosure. An expression used in the singular encompasses the expression of the plural, unless it has a clearly different meaning in the context.

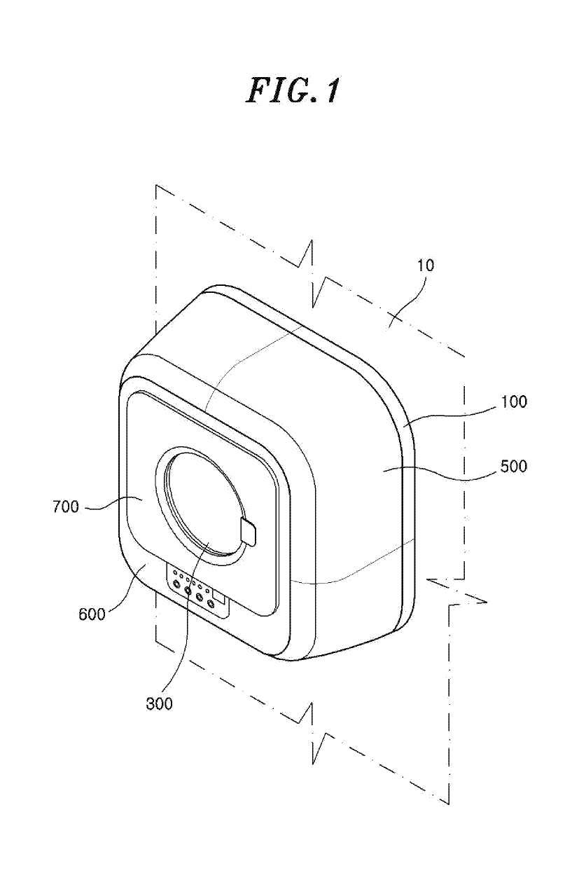

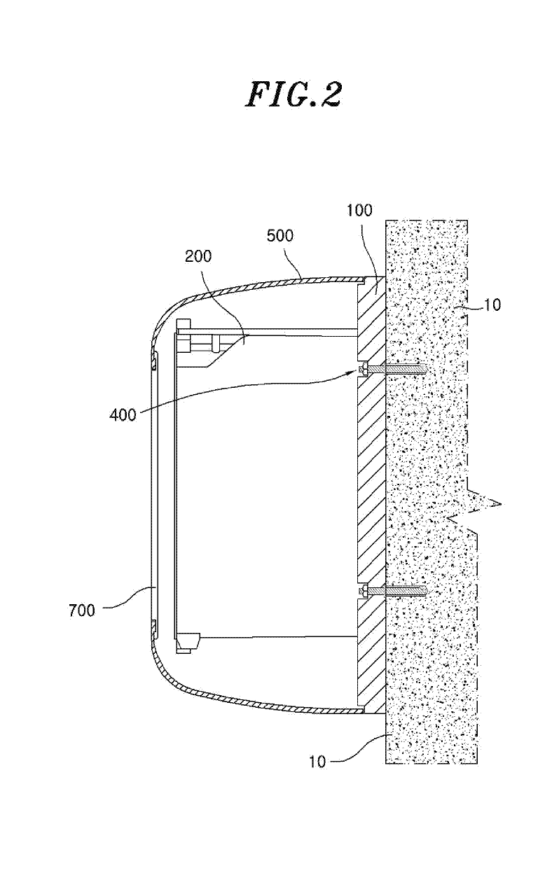

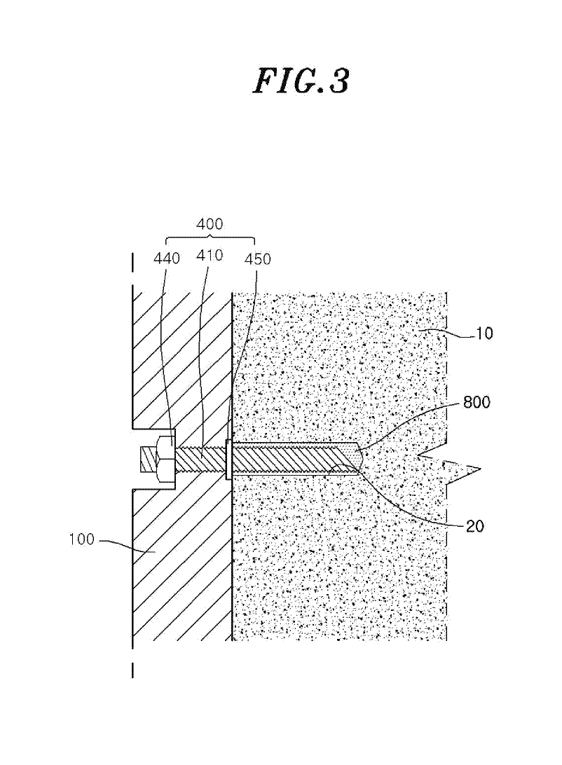

FIG. 1 illustrates a perspective view of an exemplary wall-mounted washing machine according to one embodiment of the present disclosure. FIG. 2 illustrates a partial sectional view of the exemplary wall-mounted washing machine according to one embodiment of the present disclosure. FIG. 3 illustrates an enlarged sectional view of an exemplary coupling mechanism between the wall-mounted washing machine and a lightweight wall according to one embodiment of the present disclosure.

Referring to FIGS. 1 to 3, the wall-mounted washing machine according to one embodiment of the present disclosure may include a rear panel 100, a tub 200, a drum 300, a housing 500, a cover 600, a front door 700 and a fastener kit 400. The wall-mounted washing machine may be securely affixed to the structurally-weak lightweight wall 10.

More specifically, the rear panel 100 is a support frame which can be affixed to the porous wall 10 through the fastener kit 400. The rear panel 100 may be rectangular-shaped with round corners. However, the rear panel can be of any suitable shape without departing from the scope of the present disclosure, such as circular or elliptical.

The tub 200 may be integrally formed with the rear panel 100. The integral formation of the rear panel 100 with the tub 200 reduces or eliminates the need for additional components for supporting the tub 200, such as a damper, a damping spring and the like. Thereby, the number of components and the overall size of the wall-mounted washing machine can be reduced. In particular, if the rear panel 100 is made of the same material as the tub 200, for example, a synthetic resin, the rear panel 100 and the tub 200 may be simultaneously formed by performing insert-injection once. This can further reduce the time and cost for manufacturing the rear panel 100 and the tub 200.

The tub 200 is a cylindrical reservoir integrally formed with the rear panel 100 and used to contain washing water. The tub 200 may receive washing water from a water supply device. The washing water may be drained from the tub 200 to the outside through a drain device. In this regard, the water supply device may include a water supply pipe as a water supply path through which the washing water is supplied. It may also include a water supply valve to control the flow rate of the washing water supplied into the tub 200 through the water supply pipe. The drain device may include a drain pump configured to generate pressure to draw the washing water, a drain pipe providing a path for draining washing water, and a drain port through which the washing water is drained from the drain pipe.

The drum 300 may be rotatably installed in the tub 200. The drum 300 is a cylindrical container configured to accommodate laundry or other washing objects. The drum may rotate in the tub 200. For example, the drum 300 may be driven by a drive device and can make half or full rotations within the tub 200. The drive device may include a drive motor and a drive shaft rotatably coupled to the drive motor.

During operation, laundry is loaded into and washed by the drum 300. Rotation of the drum 300 typically causes moderate vibration which can be effectively attenuated due to the firm coupling between the fastener kit 400 and the wall surface. However, vibration generated in the dewatering and rinsing cycles may not be sufficiently attenuated. A shock-absorbing member 450 for attenuating vibration may be disposed between the rear panel 100 and the porous wall 10. The shock-absorbing member 450 is described below in greater detail.

The housing 500 is coupled to the rear panel 100 and contains the tub 200. The housing 500 may be formed in a cylindrical shape with front and rear openings. The rear end portion of the housing 500 may be removably coupled to the rear panel 100 using fixing members such as screws or the like.

The cover 600 may be circular-shaped and mounted to the front opening of the housing 500. The lower portion of the cover 600 may have push buttons for a user to control the washing machine, a display window, and the like. An opening portion may be formed in the central region of the cover 600. The front door 700 may be mounted to the opening portion of the cover 600 to open and close an inner space of the tub 200.

The chemical anchor 800 may significantly enhance the bonding between an anchor rod 410 of the fastener kit 400 and the inner surface of the fastening hole 20. The chemical anchor 800 may be provided in the form of a capsule filled with a bonding material or may be provided in the form of a pack filled with a bonding material so that the bonding material can be injected into the fastening hole 20 using an injection gun.

In the present embodiment, the chemical anchor 800 having a capsule form is placed in the fastening hole 20. The anchor rod 410 of the fastener kit 400 is inserted into the fastening hole 20 with the chemical anchor 800 therein. Alternatively, the chemical anchor 800 may be injected into the fastening hole 20 of the lightweight wall 10 with an injection gun. The anchor rod 410 may be inserted into the fastening hole 20 after the chemical anchor 800 is injected.

The fastener kit 400 can securely affix the washing machine to the lightweight wall 10 through the fastening hole 20 in the lightweight wall 10.

The fastener kit 400 may include an anchor rod 410 having one end portion inserted into the fastening hole 20 and the other end portion coupled to the rear panel 100. A fastening nut 440 is used to affix the other end portion of the anchor rod 410 to the rear panel 100. A shock-absorbing member 450 is disposed between the lightweight wall 10 and the rear panel 100 and fitted to the anchor rod 410 to absorb vibration.

in this regard, one end portion of the fastening hole 20 is inserted into the fastening hole 20 by penetrating the chemical anchor 800. Thus, a bonding liquid contained in the chemical anchor 800 hardens in the fastening hole 20 to strongly maintain the bonding between the wall and the anchor rod 410.

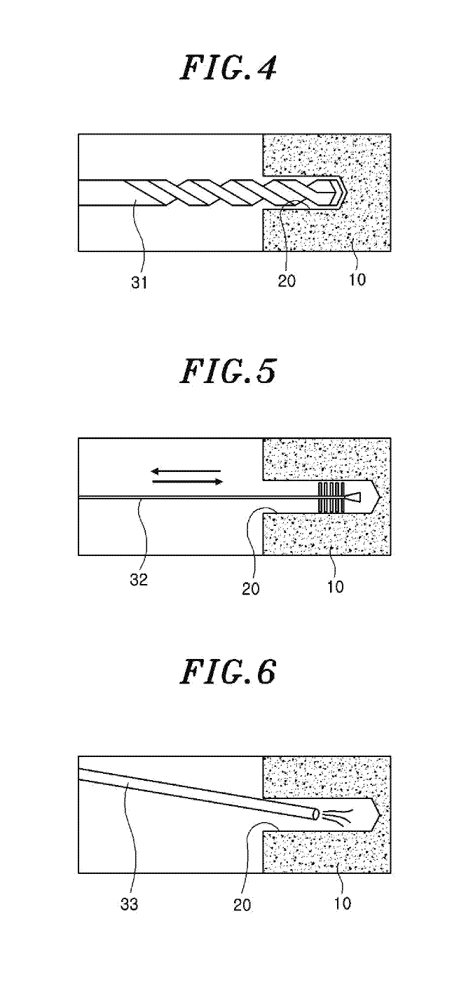

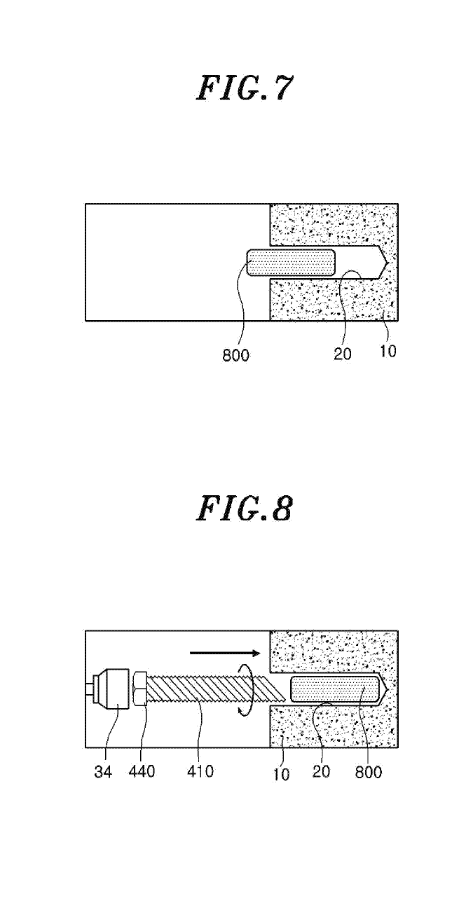

FIG. 4 illustrates a process in which the fastening hole is formed in the lightweight wall according to one embodiment of the present disclosure. FIG. 5 is a cross-sectional view illustrating an exemplary process in which debris-like extraneous material is removed from the fastening hole using a cleaning brush prior to mounting the washing machine according to one embodiment of the present disclosure on the lightweight wall. FIG. 6 is a cross-sectional view illustrating an exemplary process in which particle-like extraneous material is removed from the fastening hole using an air gun prior to mounting the washing machine according to one embodiment of the present disclosure on the lightweight wall. FIG. 7 is a cross-sectional view illustrating an exemplary process in which the chemical anchor is placed into the fastening hole according to one embodiment of the present disclosure. FIG. 8 is a cross-sectional view illustrating an exemplary process in which the anchor rod is inserted into and affixed to the wall in order to install the wall-mounted washing machine according to one embodiment of the present disclosure.

For example, as illustrated in FIG. 4, the fastening hole 20 is formed in the lightweight wall 10 using a drill 31. Then, as illustrated in FIGS. 5 and 6, extraneous materials existing within the fastening hole 20 are removed using a cleaning brush 32 and an air gun 33. Thereafter, as illustrated in FIG. 7, the chemical anchor 800 is disposed in the fastening hole 20. As illustrated in FIG. 8, the anchor rod 410 is rotationally struck by a hammer drill 34 and is inserted into the fastening hole 20 with the chemical anchor 800 therein.

At this time, the chemical anchor 800 is drilled by the anchor rod 410. The bonding liquid contained in the chemical anchor 800 spreads in the fastening hole 20. As the bonding liquid hardens, the anchor rod 410 may be firmly affixed to the inner surface of the fastening hole 20. After one end portion of the anchor rod 410 is affixed to the lightweight wall 10, the rear panel 100 is affixed to the other end portion of the anchor rod 410 using the fastening nut 440. The shock-absorbing member 450 is interposed between the lightweight wall 10 and the rear panel 100 to reduce vibration and noise generated during operation of the washing machine and transmitted to the lightweight wall 10.

In a wall-mounted washing machine according to a modification of the present disclosure, if vibration of the washing machine generated in the course of dewatering and rinsing the washing objects is expected to be small, the shock-absorbing member 450 may not be needed. In this case, the omission of the shock-absorbing member 450 from the washing machine makes it possible to reduce the number of components and the number of steps.

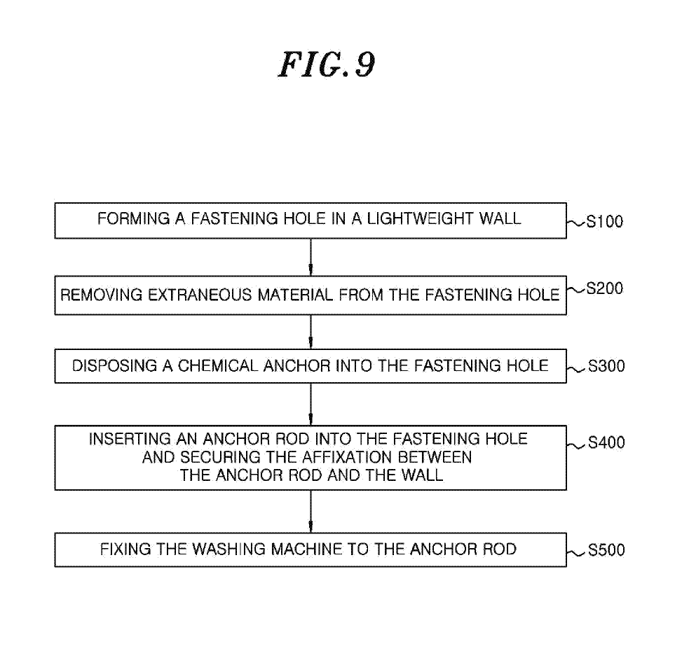

FIG. 9 is a flowchart illustrating an exemplary method of installing a washing machine to a lightweight wall according to one embodiment of the present disclosure.

As illustrated in FIG. 9, the method of mounting the washing machine according to one embodiment of the present disclosure may include: forming a fastening hole in a lightweight wall (S100); removing extraneous material from the fastening hole (S200); disposing a chemical anchor into the fastening hole (S300) ; inserting an anchor rod into the fastening hole and securing the affixation between the anchor rod and the wall (S400); and fixing the washing machine to the anchor rod (S500).

At the step S100, the fastening hole may be formed using a drill 31. The depth of the fastening hole 20 may be selected based on the strength, material and shape of the lightweight wall 10.

At the step S200, the fastening hole 20 is cleaned to remove the extraneous material generated during drilling. For example, debris-like extraneous material may be first removed using a cleaning brush 32 and particle-like extraneous material or others may be secondarily removed by an air gun 33.

At the step S300, a chemical anchor 800 having a capsule form is placed into the fastening hole 20. Alternatively, the chemical anchor 800 may be injected into the fastening hole 20 using an injection gun.

At the step S400, to affix the anchor rod in the fastening hole, the end portion of the anchor rod 410 may be rotationally struck by a hammer drill 34 so that the anchor rod 410 penetrates the chemical anchor 800 inserted into the fastening hole 20. At this time, the chemical anchor 800 is penetrated by the anchor rod 410. Thus, the bonding liquid contained in the chemical anchor 800 spreads in the fastening hole 20. As the bonding liquid hardens, the anchor rod 410 may be firmly affixed to the wall through contact with the inner surface of the fastening hole 20.

At the step S500, the rear panel 100 is affix to the other end portion of the anchor rod 410 using the fastening nut 440. At this time, the shock-absorbing member 450 is interposed between the lightweight wall 10 and the rear panel 100. This can restrain vibration and noise generated during operation of the washing machine from being transmitted to the lightweight wall 10.

As described above, according to embodiments of the present disclosure, a washing machine can be mounted on a structurally-weak lightweight wall. Furthermore, vibration caused by washing machine operations, especially in dewatering and rinsing cycles, can be attenuated and restrained from being transmitted to the lightweight wall.

Thus, noise generated by vibration can be prevented. This can also significantly reduce the risk of the washing machine falling from the wall due to a failure of the fastening mechanism.

Although exemplary embodiments of the present disclosure are described above with reference to the accompanying drawings, those skilled in the art will understand that the present disclosure may be implemented in various ways without changing the necessary features or the spirit of the present disclosure.

Therefore, it should be understood that the exemplary embodiments described above are not limiting, but only an example in all respects. The scope of the present disclosure is expressed by claims below, not the detailed description, and it should be construed that all changes and modifications achieved from the meanings and scope of claims and equivalent concepts are included in the scope of the present disclosure.

From the foregoing, it will be appreciated that various embodiments of the present disclosure have been described herein for purposes of illustration, and that various modifications may be made without departing from the scope and spirit of the present disclosure. The exemplary embodiments disclosed in the specification of the present disclosure do not limit the present disclosure. The scope of the present disclosure will be interpreted by the claims below, and it will be construed that all techniques within the scope equivalent thereto belong to the scope of the present disclosure.

1. A washing machine comprising:
a rear panel; and
a fastener kit comprising a chemical anchor and an anchor rod, wherein the anchor rod comprises a first end portion and a second end portion, wherein the first end portion is configured to be inserted in a fastening hole formed in a wall, and wherein the second end portion is configured to be coupled to the rear panel,
wherein extraneous material is removed from the fastening hole using a cleaning brush or using an air flow.

2. The washing machine of claim 1 further comprising: a tub integrally formed with the rear panel and configured to contain washing water.

3. The washing machine of claim 1, wherein the fastener kit further comprises a fastening nut configured to fix the second end portion of the anchor rod to the rear panel.

4. The washing machine of claim 2, wherein the fastener kit further comprises a shock-absorbing member operable to be disposed between the wall and the rear panel and coupled to the anchor rod to absorb vibration.

5. The washing machine of claim 1, wherein the chemical anchor comprises a capsule in form and further comprising a bonding liquid for bonding the anchor rod to the wall.

6. The washing machine of claim 1 further comprising a rotatable drum configured to contain laundry.

7. A washing machine comprising:
a housing;
a tub configured to contain washing water;
a rear panel configured to couple the washing machine to a wall through a fastener kit and a chemical anchor; and
a shock-absorbing member,
wherein:
the rear panel is operable to be affixed to the wall;
the chemical anchor is operable to be disposed in a fastening hole formed in the wall; and
the fastener kit comprises one end portion operable to be disposed in the fastening hole and another end portion coupled to the rear panel; and
wherein further the shock-absorbing member is operable to be disposed between the wall and the rear panel and fitted to the fastener kit,
wherein extraneous material is removed from the fastening hole using a cleaning brush or using an air flow.

8. The washing machine of claim 7, wherein the tub is integrally formed with the rear panel.

9. The washing machine of claim 7, wherein the fastener kit comprises an anchor rod.

10. The washing machine of claim 7, wherein the fastener kit further comprises a fastening nut configured to couple the anchor rod to the rear panel.

11. The washing machine of claim 9, wherein the chemical anchor is operable to enhance bonding between the anchor rod and an inner surface of the fastening hole.

12. The washing machine of claim 7, wherein the chemical anchor comprises a bonding liquid.

13. A method of installing a washing machine on a wall, the method comprising:
forming a fastening hole in the wall;
removing extraneous material from the fastening hole;
disposing a chemical anchor into the fastening hole;
inserting an anchor rod into the fastening hole and affixing the anchor rod in the fastening hole through the chemical anchor; and
affixing the washing machine to the anchor rod,
wherein the removing extraneous material comprises removing extraneous material using a cleaning brush and removing the extraneous material using an air flow.

14-15. (canceled)

16. The method of claim 13, wherein the affixing the washing machine to the anchor rod comprises affixing a rear panel of the washing machine to the anchor rod.

17. The method of claim 13, wherein the inserting the anchor rod into the fastening hole comprises rotationally striking an end portion of the anchor rod to penetrate the chemical anchor in the fastening hole.
